(19) United States
(12) Patent Application Publication
(10) Pub. No.: US 2011/0094293 A1
(43) Pub. Date: Apr. 28, 2011

(54) Oxygen Monitor

(76) Inventor: Paul N. Klein, Chatsworth, NJ (US)

(21) Appl. No.: 12/606,218

(22) Filed: Oct. 27, 2009

(51) Int. Cl. G01N 27/74; G01N 7/00

(52) U.S. Cl. 73/31.05

(57) ABSTRACT

An oxygen monitor which includes a magnetic field device for creating a magnetic field in a gas stream, and a Hall effect device for sensing the strength of the magnetic field in the gas stream. The magnetic field is proportional to the magnetic susceptibility of the oxygen in the stream, which is a function of the partial pressure of the gas, which provides the oxygen purity of the gas.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to an oxygen monitor. More specifically, but without limitation, the present invention relates to an oxygen monitor that utilizes the Hall Effect to measure bulk oxygen purity.

There are a number of methods utilized to measure bulk purity of oxygen. Oxygen purity is normally expressed as percent oxygen by volume. To establish basic control and accuracy of the measurement, flow and gas temperature are controlled to some designer established limit. Other methods of establishing the quantity of a component in a gas mixture can be expressed as the mass fraction or partial pressure of the gas component of interest. The higher the mass fraction or partial pressure of a specific gas component in a mixture and the closer it approaches the system weight or pressure, the more the percent volume approaches one hundred (100) percent. These values are all directly related. Consequently, when purity is being addressed, it will be generally referred to as the partial pressure of the gas mixture.

Oxygen is a highly paramagnetic gas, while other gases exhibit very little to no paramagnetic properties. Oxygen has a specific magnetic susceptibility based on pure gas. Any gas stream that has an oxygen component will have a magnetic susceptibility, and that susceptibility is linearly based on the amount of oxygen in the gas stream.

Mixed gases are normally prepared by utilizing either partial pressure or mass. Using pV=mRT, where p is the pressure increase of the component in absolute pressure, V is the volume of the pressure vessel, R is the gas constant for the specific gas component and T is the system temperature in absolute temperature, one can solve for m, or the mass of the gas component (or gas of interest). By determining the density of the gas component at the specified temperature, the volume can be determined by dividing the mass by the density. Percent volume or bulk purity is the volume of the gas component calculated divided by the total gas volume times one hundred.

The primary methods of measuring oxygen purity rely on the partial pressure of oxygen. Previous methods include the poloragraphic method and use of ceramic technology. Ceramic technology utilizes a ceramic material instead of a gel cell. This requires heating the ceramic material to a high temperature, and response is non-linear, which can cause errors in readings. Additionally this method requires a high power draw for the heaters.

The poloragraphic method utilizes a cell filled with a conductive gel that is covered by a permeable membrane with a voltage across the cell. The gas flow is passed over the membrane, and the oxygen within the gas flow makes the gel conductive. The conductivity of the cell is based on the partial pressure of the gas mixture. As partial pressure of the oxygen increases, the conductivity increases and the resulting current is a direct indicator of the percent of oxygen present in the gas sample. The cell has useable life span, the gel cell is temperature sensitive and often has to be recharged or replaced. Another currently used method is the use of a paramagnetic sensor. This sensor utilizes two nitrogen-filled metal spheres that are re-arranged in rotational symmetry within a magnetic field (this is also referred to as a type of dumb-bell assembly) all contained within a cell. The gas to be measured passes through the sensor. If the sample gas contains oxygen, the oxygen changes the magnetic field. The nitrogen-filled spheres are subjected to a torque based on the change in the magnetic field, causing the spheres to rotate. The force required to bring the dumbbell assembly back to neutral is directly proportional to the oxygen concentration. In these types of oxygen monitors, the dumb-bell assembly is very fragile and expensive. Additionally, these types of monitors often utilize a method of indication or control that is proprietary to the specific brands of monitors used.

Thus, there is a need in the art to provide an oxygen monitor without the limitations inherent in present methods.

### SUMMARY

It is a feature of the invention to provide an oxygen monitor for measuring oxygen purity. The monitor includes a magnetic field device for creating a magnetic field in a gas stream, and a Hall effect device for sensing the strength of the magnetic field in the gas stream. The magnetic field is proportional to the magnetic susceptibility of the oxygen in the gas stream, which is a function of the partial pressure of the oxygen within the gas stream, which provides the oxygen purity of the gas.

It is a feature of the invention to provide an oxygen monitor that is inexpensive and rugged.

It is a feature of the invention to provide an oxygen monitor that requires no moving parts and requires less power than other monitors require. It is another feature of the invention to provide an oxygen monitor that does not require any chemical gels subject to drying.

### DRAWINGS

These and other features, aspects and advantages of the present invention will become better understood with reference to the following description and appended claims, and accompanying drawings wherein:

FIG. 1 is a perspective view of the oxygen monitor;

FIG. 2 is a cross sectional view of the oxygen monitor along the cross section A-A, along with corresponding components; and,

FIG. 3 is a cross sectional view of an embodiment of the gas cell and Hall effect device.

### DESCRIPTION

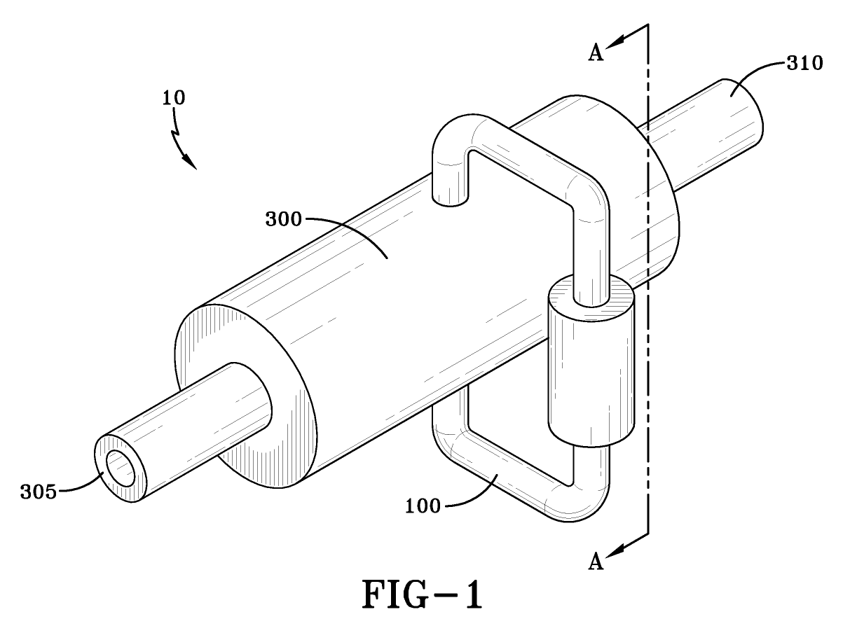

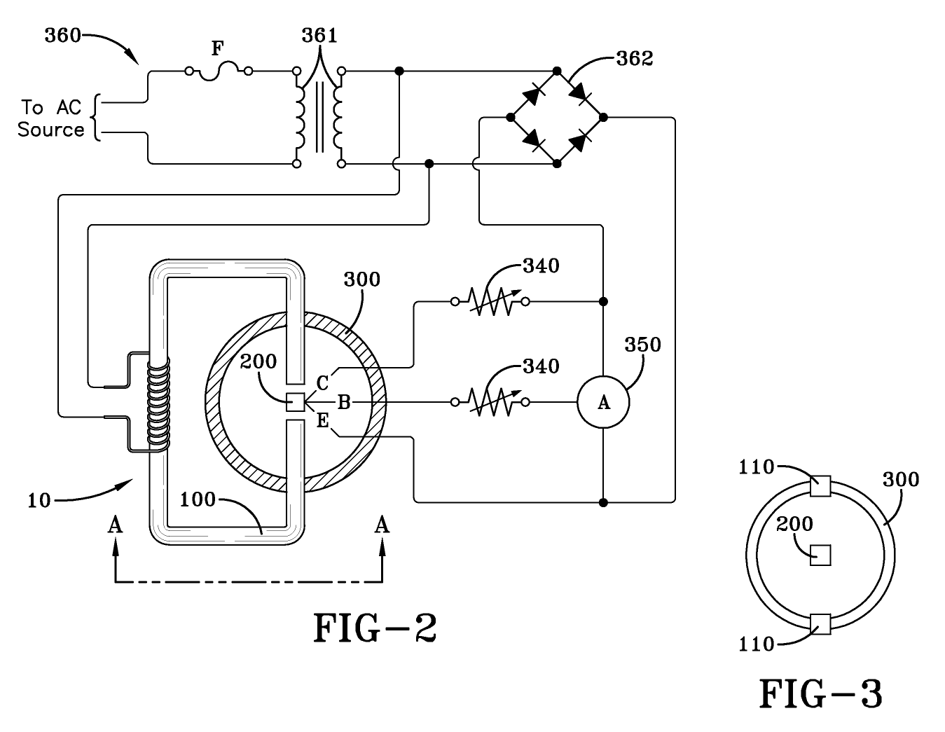

The preferred embodiment of the present invention is illustrated by way of example below and in FIGS. 1-3. As seen in FIGS. 1 and 2, the oxygen monitor 10 includes a magnetic field device 100 for creating a focused magnetic field in a gas stream disposed within a gas cell 300, and a Hall effect device 200 for sensing the strength of the magnetic field in the gas stream. The magnetic field is proportional to the magnetic susceptibility of the gas, which is a function of the partial pressure of the oxygen within the gas stream, which is a function of the oxygen purity of the gas.

In the description of the present invention, the invention will be discussed in a bulk purity oxygen environment; however, this invention can be utilized for any type of need that requires use of an oxygen monitor.

As shown in FIG. 3, the magnetic field device 100 may be magnets 110 disposed across from each other along the gas cell 300 (specifically on the circumference of the gas cell 300 if the gas cell 300 has a circular cross section), creating a magnetic field in between the magnets 110 within the gas cell 300. However, the magnetic field device 100 may be any type of magnetic field device practicable. When using magnets 110, North and South poles are required to generate a magnetic field.

The Hall effect refers to the potential difference (Hall voltage) on the opposite sides of an electrical conductor through which an electric current is flowing, created by a magnetic field applied perpendicular to the current. A Hall effect device 200 may be defined, but without limitation, as a transistor that varies its output current in response to changes in magnetic field. The Hall effect device 200 includes three differently doped semiconductor regions, the emitter region, the base region and the collector region. Each semiconductor region is connected to a terminal, an emitter E, a base B and a collector C. The Hall effect device 200 reacts to the magnetic field, whereby the conduction of the Hall effect device is proportional to the partial pressure of the gas. From the partial pressure of the gas the oxygen bulk purity of a gas may be determined The Hall effect device must be perpendicular to the magnetic field (the Hall effect device 200 must be perpendicular to the ends of the magnetic core to be perpendicular to the magnetic field).

The Hall effect device 200 may be disposed within a gas cell 300. A gas cell 300 may be defined as, but without limitation, as any enclosed space which will house the necessary components and be suitable for the service intended. As shown in FIG. 1-3, the gas cell 300 may have a circular cross section and shaped like a cylinder. The gas cell 300 may include an input aperture 305 and an output aperture 310. The input aperture 305 and the output aperture 310 can be used for controlling the flow rate of the gas within the gas cell 300 and therefore the overall response of the system. The gas cell 300 may be any size, practicable.

The oxygen monitor 10 may also include an amp meter 350 for reading the amperage or electrical current emitted by the Hall effect device 200 to provide purity readout. Because, electrical current and magnetic susceptibility are related, the electrical current indicates the magnetic susceptibility of the gas being tested. A power supply 360 is needed for supplying voltage to the Hall effect device 200 and power for the generation of the magnetic field. As shown in FIG. 2, the power may be supplied by an AC transformer 361. The AC transformer 361 provides the required voltages for DC controls and AC for generating the magnetic field. The AC transformer 361 may be attached to a rectifier 362 to change the electricity from AC to DC.

In operation of the preferred embodiment, power from an AC source 360 enters the AC transformer 361. The AC transformer 361 provides required voltage to DC controls and AC for generating the magnetic field. Gas enters the input aperture 305 and into the gas cell 300. Gas passes the Hall effect device 200, and along with the magnetic field creates an output from the Hall effect device 200 that includes output from the collector C, the base B, and the emitter E. The collector C output and base B output each pass through separate variable resistors 340 and all three enter into amp meter 350. The amp meter 350 reads the amperage of the Hall effect device 200 which in turn provides oxygen purity readout. Prior to usage, the oxygen monitor 10 must be calibrated by using two span gasses—a zero gas (a gas absent of any oxygen or known low content) and a known purity gas (a gas where the high oxygen content is known). The zero gas will have a zero or low reading on the amp meter, while the known high purity gas will have a high electrical current. The current measured is directly proportional to the oxygen content of the gas stream. If a plot is made of current verses oxygen purity based on the calibration gases, a straight line can be drawn through the two (2) points. From this plot, for any current value, the oxygen purity value, the corresponding oxygen content can be determined by volume in percentage. In use, the amp meter is labeled in “Percent Oxygen.” The variable resistors 340 are then used to bring the low and high settings into adjustment based on the scale used. Additional circuitry may be required as necessary to drive the amp meter full scale or other specific scale as parameters dictate.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to a certain preferred embodiment thereof, other embodiments are possible. Therefore, the spirit and scope of the appended claims should not be limited to the description of the preferred embodiment(s) contained herein.

What is claimed is:

1. An oxygen monitor for measuring oxygen purity of a gas, the monitor comprising:
a magnetic device for creating a focused magnetic field in a gas stream; and,
a Hall effect device for sensing the strength of the focused magnetic field, the focused magnetic field being proportional to the magnetic susceptibility of the gas, which is a function of the partial pressure of the oxygen within the gas stream, which is a function of the oxygen purity of the gas stream.

2. The monitor of claim 1, wherein the monitor further includes a gas cell, the Hall effect device disposed within a gas cell, the gas cell having an input aperture and an output aperture, the input aperture for directing the gas toward the Hall effect device.

3. The monitor of claim 2, wherein the monitor further includes an amp meter for reading the amperage of the Hall effect device for the gas within the gas cell, the amp meter providing the oxygen purity.

4. The monitor of claim 3, wherein the monitor further includes a voltage supply for supplying voltage to the Hall effect device.

5. An oxygen monitor for measuring oxygen purity of a gas, the monitor comprising:
a magnetic device for creating a focused magnetic field in a gas stream;
a gas cell for holding the gas stream, the gas cell including an input aperture and a output aperture such that the gas stream may enter and exit the gas cell;
a Hall effect device for sensing the strength of the focused magnetic field in the gas stream, the Hall effect device disposed within the gas cell, the strength of the focused magnetic field in the gas stream being proportional to the magnetic susceptibility of the gas, which is a function of the partial pressure of the oxygen within the gas stream, which is a function of the oxygen purity of the gas stream; and,
an amp meter for reading the amperage of the Hall effect device for the gas stream within the gas cell, the amperage value determining the magnetic susceptibility of the gas stream and the oxygen purity of the gas in the gas stream.

6. A method for measuring oxygen purity of a gas, the method comprising:
creating a focused magnetic field in a gas stream;
sensing the strength of the focused magnetic field in a gas stream via a Hall effect device, the focused magnetic field being proportional to the magnetic susceptibility of the gas, which is a function of the partial pressure of the oxygen of the gas stream, which is a function of the oxygen purity of the gas stream.
